(19) United States
(12) Patent Application Publication
(10) Pub. No.: US 2006/0092147 A1
(43) Pub. Date: May 4, 2006

(54) Pulse width modulation technique and apparatus for a display array

(76) Inventor: Ben D. Roberts, Sunnyvale, CA (US)

Correspondence Address: TROP PRUNER & HU, PC, 8554 KATY FREEWAY, SUITE 100, HOUSTON, TX, 77024, US

(21) Appl. No.: 10/980,391

(22) Filed: Nov. 3, 2004

(51) Int. Cl. G09G 5/00

(52) U.S. Cl. 345/204

(57) ABSTRACT

A technique includes applying a first pulse encoding scheme to a first group of bits of a digital value and applying a second pulse encoding scheme different from the first pulse encoding scheme to a second group of bits of the digital value. The technique includes combining sequences generated by the first and second pulse encoding schemes to derive a display device.

### BACKGROUND

The invention generally relates to a pulse width modulation technique and apparatus for a display array.

Electrically controlled display arrays are typically used to spatially modulate light for purposes of forming an image. For example, a liquid crystal display (LCD) array and a mirror array are two different types of display arrays that may be used to modulate light for purposes of forming an image. Each display array includes pixel cells that are electrically-controlled to form corresponding pixels of the image. The LCD array includes liquid crystal (LC) pixel cells, and the mirror array includes mirror-based pixel cells.

The mirror array (a mirror array of a digital micromirror device (DMD), for example) may be part of a mirror-based projection system in which the array reflects light to form an image on a projection screen of the system. The mirror array includes mirrors that are selectively tilted to spatially control the reflection of light to and away from the screen to form the image. More specifically, each mirror of the array may be uniquely associated with one pixel of the image so that the mirror controls the intensity of the associated pixel. The projection system controls the tilt angle of each mirror to control when the mirror reflects light toward, and the system controls the tilt angle of the each mirror to control when the mirror reflects light away from the associated pixel. To form a two-tone black and white image, the projection system tilts mirrors of the array at angles that reflect light toward the screen to form white pixels and tilts other mirrors of the array at angles that reflect light away from the screen to form black pixels.

For purposes of forming a gray scale intensity for a particular pixel, the projection system may control the associated mirror pursuant to a pulse width modulation (PWM) cycle. More specifically, pursuant to a PWM cycle, a gray scale intensity for a particular pixel is created by moving the mirror between an angle that reflects light toward the pixel (during an “on time” of the cycle) and an angle that reflects light away from the pixel (during an “off time” of the cycle). The fraction of time in which light is directed toward the pixel as compared to the duration of the PWM cycle determines the average brightness, or gray scale intensity, of the pixel. Thus, the viewer's eyes integrate these rapid flashes into a perception of a gray scale intensity for the pixel.

### BRIEF DESCRIPTION OF THE DRAWING

FIG. 1 is a schematic diagram of a projection system according to an embodiment of the invention.

FIG. 2 is a schematic diagram of a mirror array device according to an embodiment of the invention.

FIGS. 3 and 4 are flow diagrams depicting techniques to drive a pixel cell according to embodiments of the invention.

FIGS. 5, 6 and 7 are illustrations of a bit splitting pulse width modulation technique.

FIGS. 8, 9 and 10 are waveforms of pulse sequences derived from the bit splitting pulse width modulation technique depicted in FIGS. 5, 6 and 7.

FIGS. 11, 12 and 13 are waveforms depicting a single transition pulse width modulation technique.

FIGS. 14, 15, 16 and 17 are illustrations of a pulse width modulation technique according to an embodiment of the invention.

FIGS. 18, 19, 20 and 21 are waveforms of pulse sequences derived from the pulse width modulation technique depicted in FIGS. 14, 15, 16 and 17 according to an embodiment of the invention.

FIG. 22 is a schematic diagram of encoding circuitry to drive pixel cells according to an embodiment of the invention.

FIGS. 23, 24, 25, 26, 27, 28, 29, 30, 31, 32, 33, 34, 35, 36, 37, 38, 39, 40, 41 and 42 are waveforms depicting operation of the encoding circuitry of FIG. 22 according to an embodiment of the invention.

FIG. 43 is a schematic diagram of a projection system according to an embodiment of the invention.

FIGS. 44 and 45 are flow diagrams depicting techniques to control and display an image according to an embodiment of the invention.

FIG. 46 is a flow diagram depicting a technique to load data according to an embodiment of the invention.

### DETAILED DESCRIPTION

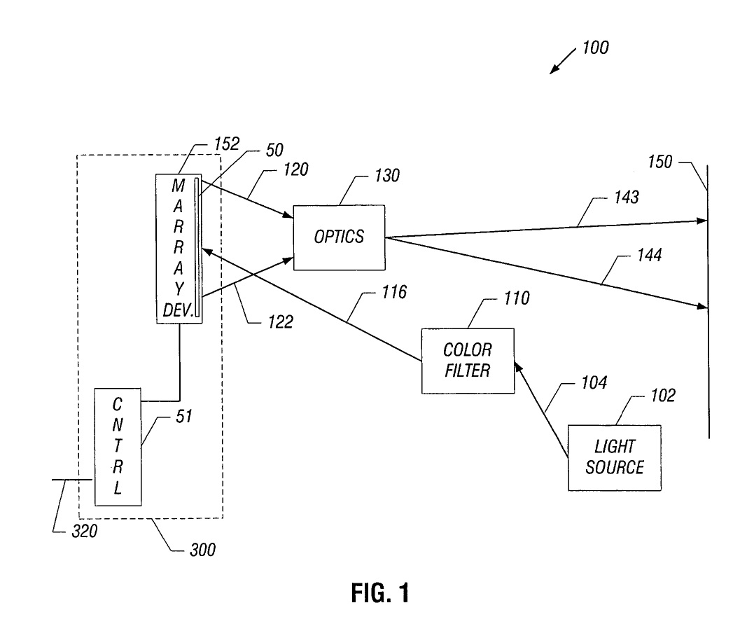

Referring to FIG. 1, in accordance with an embodiment of the invention, a projection system 100 modulates light to form projected images on a projection screen 150. More specifically, in some embodiments of the invention, the projection system 100 may include a light source 102 that forms a beam 104 of light that is incident upon a color filter 110 (a color wheel, for example). The color filter 110 converts the beam 104 into successive primary color beams that are spatially modulated by pixel cells of a display device. In some embodiments of the invention, each pixel cell includes a mirror of a mirror array 50. The mirror array 50, in turn, may be part of a mirror display device 152 (described below).

The mirror array 50 reflects the colored beams, and the reflected beams, in turn, are focused by optics 130 of the projection system 100 onto the projection screen 150 to form a perceived color composite image on the screen 150. In some embodiments of the invention, the individual mirrors of the mirror array 50 control the intensity values for corresponding pixels on the projection screen 150.

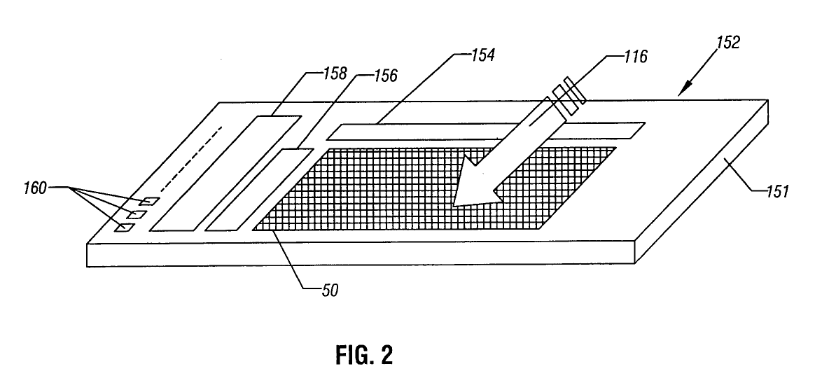

Referring to FIG. 2, in some embodiments of the invention, the mirror display device 152 includes the mirror array 50 that resides on a silicon backplane 151. The tilt angles of the mirrors of the array 50 are selectively controlled to reflect a beam 116 of incident light to form an image on the projection screen 150. The mirror array device 152 may also include line 156 and column 154 drivers, as well as the decode logic 158 that are fabricated on the silicon backplane 151. The silicon backplane 151 also includes input pads 160 that receive off chip data to control the tilt angles of the mirrors of the array 50. The decode logic 158 decodes data received from the input pads 160 and controls the line 156 and column 154 drivers accordingly to modulate the incident beam 116.

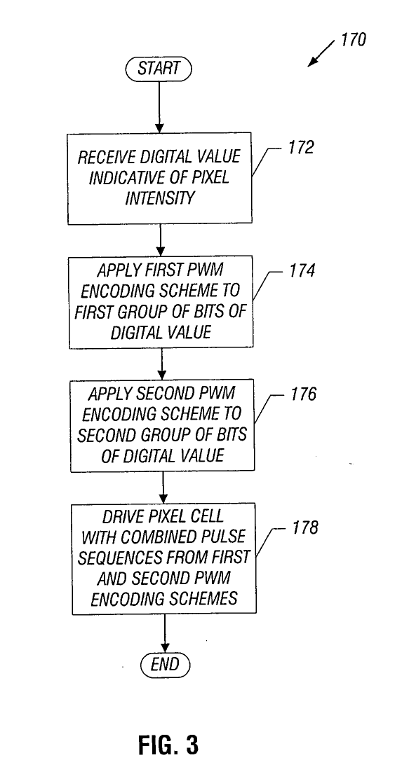

Referring back to FIG. 1, for purposes of forming gray scale intensities on the projection screen 150, the projection system 100 controls the tilt angles of the mirrors of the array 50 using a pulse width modulation (PWM) technique that combines at least two different PWM encoding schemes. More specifically, in some embodiments of the invention, control electronics 51 (part of a projection assembly 300 that includes the mirror array 50, which is coupled to the control electronics 51) of the projection system 100 may use a technique 170 that is generally depicted in FIG. 3 for purposes of controlling each mirror of the array 50. Referring to FIG. 3, in the technique 170, the control electronics 51 receives (block 172) a digital value that is indicative of an intensity for a particular pixel on the projected image and generates a control signal to control the tilt angle of the associated pixel cell (a pixel cell that includes a mirror of the mirror array 50, for example) in the following manner. First, the control electronics 51 divides the received digital value into two mutually exclusive groups of bits, in some embodiments of the invention. For example, for an eight bit digital value, the control electronics 51 may form one group of bits from the three least significant bits of the digital value and form the other group of bits from the remaining five most significant bits of the digital value.

With this grouping, the control electronics 51 applies (block 174 of FIG. 3) a first PWM encoding scheme to the first group of bits and applies (block 176) a second PWM encoding scheme to the second group of bits. The application of each PWM encoding scheme produces a corresponding pulse sequence. The control electronics 51 drives (block 178) the pixel cell in response to the combination of pulse sequences (as described below) to cause the associated pixel to have the intensity indicated by the digital value.

The PWM encoding technique described herein recognizes that different PWM encoding schemes may have different advantages and disadvantages, depending on whether the PWM encoding scheme is encoding the most significant bits (MSBs) of the digital value or the least significant bits (LSBs) of the digital value. More specifically, a particular PWM encoding scheme may be associated with a relatively low data bandwidth. In other words, this PWM encoding scheme may require less data to be sent to the display device for purposes of producing grayscale intensities than most other PWM encoding schemes. However, this low bandwidth PWM encoding scheme may produce excessive pixel flicker and artifacts. Another PWM encoding scheme may require a relatively higher data bandwidth but produce less pixel flicker and artifacts. As described below, the PWM encoding technique described herein combines two such PWM encoding schemes so that the MSBs (that may potentially produce the most pixel flicker and artifacts) of the digital value are encoded using a PWM encoding scheme that consumes more data bandwidth and produces less pixel flicker/artifacts; and the LSBs (that are not as sensitive to pixel flicker/artifacts) of the digital value are encoded using a different PWM encoding scheme that consumes less data bandwidth.

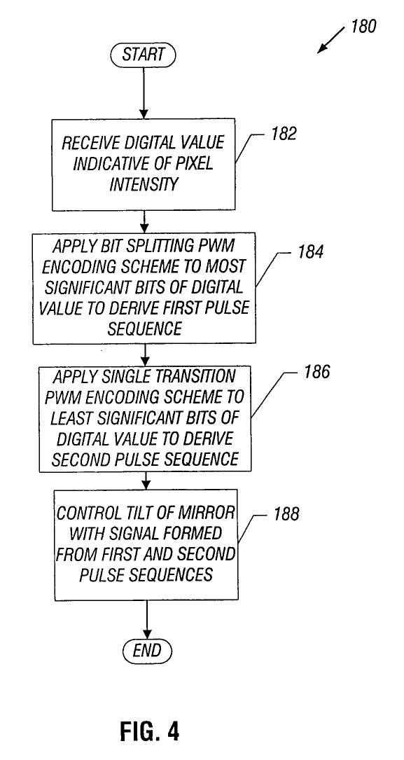

As a more specific example, in some embodiments of the invention, the control electronics 51 may use a technique 180 (generally depicted in FIG. 4) to control a mirror in response to a particular digital value that indicates an intensity for the corresponding pixel. In this technique 180, the control electronics 51 receives (block 182) a digital value that indicates a particular pixel intensity. The control electronics 51 divides the digital value into two groups of bits: a group of the MSBs and a group of the LSBs. In this manner, the control electronics 51 applies a first PWM encoding scheme to the most significant bits of the digital value and applies a second and different PWM encoding schemes to the least significant bits of the digital value. The application of these two PWM encoding schemes produces two pulse sequences that are used to drive the mirror. Each pulse sequence indicates (via a logic one state, for example) when the mirror is to be tilted toward the allocated pixel and indicates (via logic zero state, for example) when the mirror is to be tilted away from the associated pixel.

More particularly, in some embodiments of the invention, the control electronics 51 applies (block 184 of FIG. 4) a bit splitting PWM encoding scheme to the most significant bits of the digital value to derive a first pulse sequence; and the control electronics 51 also applies (block 186) a single transition PWM encoding scheme to the least significant bits of the digital value to derive a second pulse sequence. The control electronics 51 then controls (block 188) the tilt angle of the mirror with a signal that is formed from the first and second pulse sequences.

The signal either causes the mirror to reflect light toward the associated pixel (a state in which the mirror is “on”) or reflect light away from the associated pixel (a state in which the mirror is “off”). In some embodiments of the invention, the control electronics 51 concatenates the first and second pulse sequences together in time so that the control electronics 51 first controls the mirror using a signal that is indicative of the first pulse sequence and then controls the mirror using a signal that is indicative of the second pulse sequence.

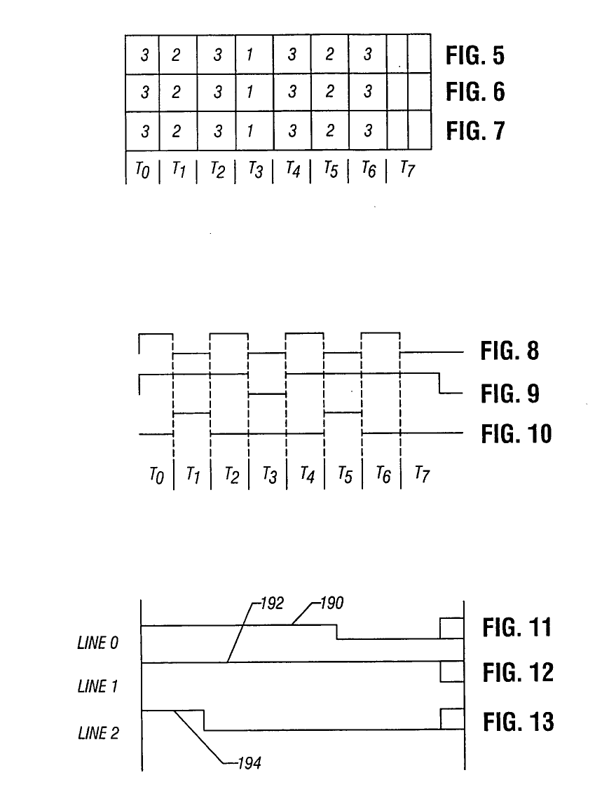

In accordance some embodiments of the invention, the first PWM encoding scheme (i.e., the scheme applied to the MSBs) is a bit splitting PWM encoding scheme, a scheme that is depicted in FIGS. 5, 6 and 7. The resultant pulse sequences for different input values (described below) are depicted in FIGS. 8, 9 and 10, respectively. For these examples, a bit splitting PWM encoding scheme is shown encoding a four bit digital value. As a more specific example, FIGS. 5 and 8 depict a PWM bit splitting encoding scheme (FIG. 5) and the resultant pulse sequence (FIG. 8) for encoding a digital value of “1000b” (wherein the “b” suffix denotes a binary representation); FIGS. 6 and 9 depict a PWM bit splitting encoding scheme (FIG. 6) and the resultant pulse sequence (FIG. 9) for encoding a digital value of “1000b”; and FIGS. 7 and 10 depict a PWM bit splitting encoding scheme (FIG. 7) and the resultant pulse sequence (FIG. 10) for encoding a digital value of “0100b.”

More specifically, FIGS. 5, 6 and 7 each depict the association of the bits of the encoded digital value to the time slots of the associated pulse sequence. As shown, each pulse sequence depicted in FIGS. 8, 9 and 10 is formed from a combination of logic one and logic zero pulses. Furthermore, each pulse sequence that is depicted in FIGS. 8, 9 and 10 is applied to a different mirror.

The numbers in each of FIGS. 5-7 indicate the particular bit (of the digital value) that controls the associated pulse sequence (i.e., controls whether the pulse sequence has a logic one or a logic zero value) during a particular time slot. For this example, the digital value being encoded has four bits (bit 3, bit 2, bit 1 and bit 0); and each pulse sequence has eight successive time slots called T₀-T₇. Thus, bit 3 controls the logic value of the associated pulse sequence during time slot T₀, bit 2 controls the logic value of the associated pulse sequence during time slot T₁, bit 3 controls the logic value of the associated pulse sequence during time slot T₂, bit 1 controls the logic value of the associated pulse sequence during time slot T₃, etc. It is noted that bit 0 controls the logic value during one half of the time slot T₇. The remaining half of the time slot T₇ is defined as being a logic zero level. FIGS. 5, 6 and 7 depict PWM bit splitting encoding scheme for three adjacent mirrors in the same column, and as can be seen, the encoding scheme is the same for each mirror.

As a more specific example, FIG. 9 depicts the pulse sequence derived from the bit splitting PWM encoding scheme being applied to a digital value of “1101b.” Referring both to FIGS. 6 and 9, bit 3 of this digital value is a “1.” Therefore, during the time slots that correspond to bit 3 (i.e., time slots T₀, T₂, T₄ and T₆), the pulse sequence has a logic one state, the state of bit 3. Continuing the example, during the time slots that correspond to bit 2 (i.e., time slots T₁ and T₅), the pulse sequence has a logic one state, the state of bit 2. During time slot T₃, the pulse sequence has a logic zero state, the state of bit 1. The least significant bit, bit 0, of the digital value sets the first half of the time slot T₀ to a logic zero state.

As can be seen from FIGS. 5-7, in the bit splitting PWM encoding scheme, each bit of the digital value being encoded may be associated with more than one time slot. Furthermore, a particular bit is associated with twice as many time slots as the next significant bit. For example, bit 3 is associated with four time slots, and bit 2 is associated with two time slots. The phrase “bit splitting” refers to ensuring that successive time slots are not controlled by the same bit. For example, time slots that are controlled by bit 3 are separated by one intervening time slot, and time slots that are controlled by bit 2 are separated by two intervening time slots.

Due to the bit splitting, potential motion artifacts and flickering effects are reduced because the more significant bits are pulsed at a faster rate within the frame display. For example, if the T₀, T₂, T₄ and T₆ time slots (i.e., the time slots controlled by bit 3) were merged together to become a continuous time slot, the associated pulse sequence remains at a single logic level for one half of the entire period of the pulse sequence. This subjects the corresponding pixel to motion artifacts and flickering effects. The drawback for the bit splitting technique PWM encoding scheme may be that since the more significant bit data is loaded several times per frame, the data bandwidth to the mirror array may be higher than other PWM encoding schemes.

Therefore, in accordance with some embodiments of the invention, another PWM encoding scheme is used for encoding the LSBs of the digital value for purposes of increasing the bandwidth to the mirror array. This technique does not use bit splitting. However, less significant bits control less time of the PWM cycle than the more significant bits. Therefore, because the least significant bits are encoded, the time in which the pulse sequence remains at a particular level is small enough to introduce minimal artifacts and flickering.

Referring to FIGS. 11, 12 and 13, in some embodiments of the invention, this other PWM encoding technique is a single transition PWM encoding technique that is applied to the least significant bits of the digital value. FIGS. 11, 12 and 13 depict pulse sequences that are derived from a single transition PWM encoding scheme for the intensity values 10, 15 and 3, respectively. Consistent with the name of the technique, each pulse sequence has a single pulse, the duration of which is set by the corresponding intensity value. Thus, the pulse sequence in FIG. 11 has a single logic one pulse 190 that has a duration that is established in response to the intensity value of “10.” The pulse sequence in FIG. 12 has a single logic one pulse 192 that has a duration that is established in response to the intensity value of “15.”. The pulse sequence in FIG. 13 has a single logic one pulse 194 that has a duration established in response to the intensity value of “3.” As can been seen the pulse 192, the pulse established in response to the largest value, has the longest duration. Likewise, the pulse 194, the pulse established in response to the smallest value, has the shortest duration.

The advantage of the above-described single transition PWM technique is that the mirror is not pulsed too rapidly, thereby providing a useful technique for dealing with slowly responding and/or asymmetrical on/off light response, which can be a non-linear function of the pulse width.

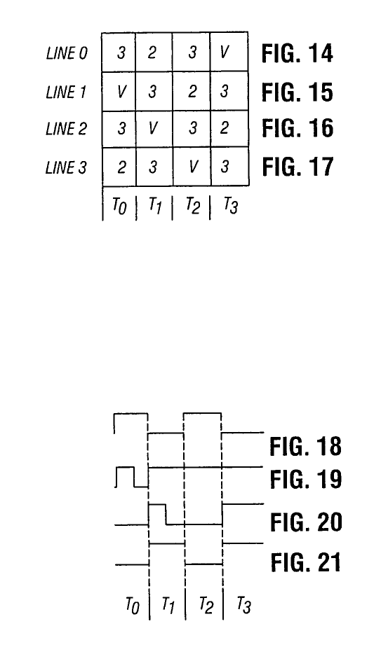

FIGS. 14, 15, 16 and 17 each illustrate the encoding of a particular digital value in accordance with an embodiment of the invention to produce pulse sequences that are depicted in FIGS. 18, 19, 20 and 21, respectively. Each pulse sequence is derived from combining the above-described bit splitting and single transition PWM encoding schemes. More specifically, in the following example, a four bit digital value that indicates the intensity for a particular pixel is assumed. The pulse sequences in this example have four equal and successive time slots called T₀, T₁, T₂, and T₃. In this example, to derive a particular pulse sequence, the two most significant bits (bits 3 and 2) of the digital value are encoded using a bit splitting PWM encoding scheme; and the two least significant bits (bits 1 and 0) of the digital value are encoded using a single transition pulse PWM encoding scheme.

For example, the pulse sequence that is shown in FIG. 18 is derived using the bit assignments that are shown in FIG. 14. Referring to FIG. 14, in time slot T₀, bit 3 of the digital value determines the logical state of the pulse sequence; in time slot T₁, bit 2 of the digital value determines the logical state of the pulse sequence; in time slot T₂, bit 3 of the digital value determines the logical state of the pulse sequence; and in time slot T₃, bits 1 and 0 control the duration of a single pulse. Thus, the numbers shown in FIG. 14 represent encoding pursuant to the bit splitting technique, and the “V” represents a time slot in which the single transition pulse technique is used.

FIG. 18 depicts the pulse sequence derived from the encoding that is shown in FIG. 14 when applied to a digital value of “1000b.” Due to bit 3 being a logical one, the pulse sequence has a logic one state in time slots T₀ and T₂. The pulse sequence has a logic zero state in time slot T₁ due to bit 2 being a logic zero. During the time slot T₃ (the time slot controlled by the single transition pulse encoding of bits 1 and 0), the pulse sequence has a logic zero state due to the bits 1 and 0 both being zero bits. FIGS. 19, 20 and 21 depict pulse sequences for the digital values “110b,” “0110b,” and “1000b,” respectively, using the encoding depicted in FIGS. 15, 16 and 17, respectively.

The sequence in which the two different PWM encoding schemes are applied may vary according to the grouping of the mirrors. For example, in some embodiments of the invention, the mirror array 50 may be partitioned into groups so that the sequence in which the two different pulse encoding schemes are applied to members of the group is different for each member. As an example, FIGS. 14, 15, 16 and 17 depict different sequences for a four member group (a group of four mirrors in the same column of the array 50, for example). As described above, for the mirror associated with the encoding depicted in FIG. 14, the bit splitting encoding scheme is applied beginning at time slot T₀ and ends at time slot T₂; and the single pulse transition encoding scheme occurs during time slot T₃. For the mirror in the group associated with the encoding shown in FIG. 15, the bit splitting encoding scheme is applied beginning at time slot T₁ and ends at time slot T₃; and the single pulse transition encoding scheme occurs during time slot T₀. For the mirror in the group associated with the encoding scheme depicted in FIG. 16, the bit splitting encoding scheme wraps around from time slot T₂ to time slot T₀; and the single pulse transition encoding scheme occurs during time slot T₁. For the mirror in the group associated with the encoding scheme depicted in FIG. 17, the bit splitting encoding scheme wraps around from time slot T₃ to time slot T₁; and the single pulse transition encoding scheme occurs during time slot T₂.

Due to the time phasing of the bit splitting and single pulse transition encoding schemes, only one pulse sequence for the group at any particular time is within a time slot in which a single pulse transition encoding scheme controls the sequence. In this manner, for time slot T₀, only the pulse sequence depicted in FIG. 15 is controlled by the single pulse transition encoding scheme; for time slot T₀, only the pulse sequence depicted in FIG. 15 is controlled by the single pulse transition encoding scheme; for time slot T₁, only the pulse sequence depicted in FIG. 16 is controlled by the single pulse transition encoding scheme, etc. Due to this phasing, a counter may be shared by all encoders of the group for purposes of generating the single transition pulses, as further described below.

The encoding scheme depicted in FIGS. 14-17 is just one example of an embodiment of the invention. In this manner, digital values having more than four bits may be encoded using the encoding techniques described herein. In general, G bits of gray scale are split between C bits to be displayed using a bit splitting encoding technique and V bits to be displayed using a single pulse transition width encoding technique, such that V+C=G. The frame period of the overall PWM cycle is divided into 2^{G} LSB clocks and 2^{C} time slots. The lines in the array are arranged in groups of 2^{C} lines (partial groups are allowed if the lines do not come out even). Lines in a group need not be contiguous, but that may be desirable, given the extra storage requirements per group.

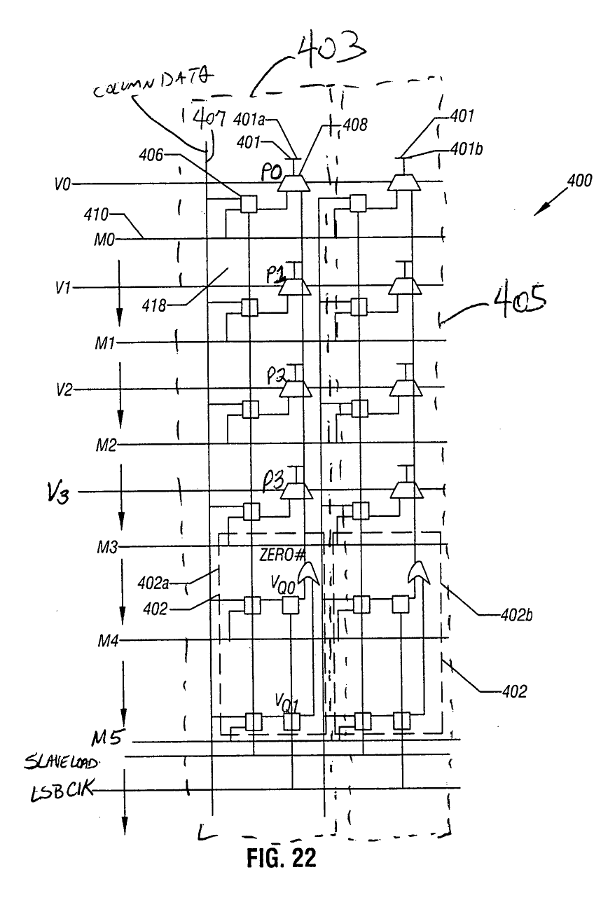

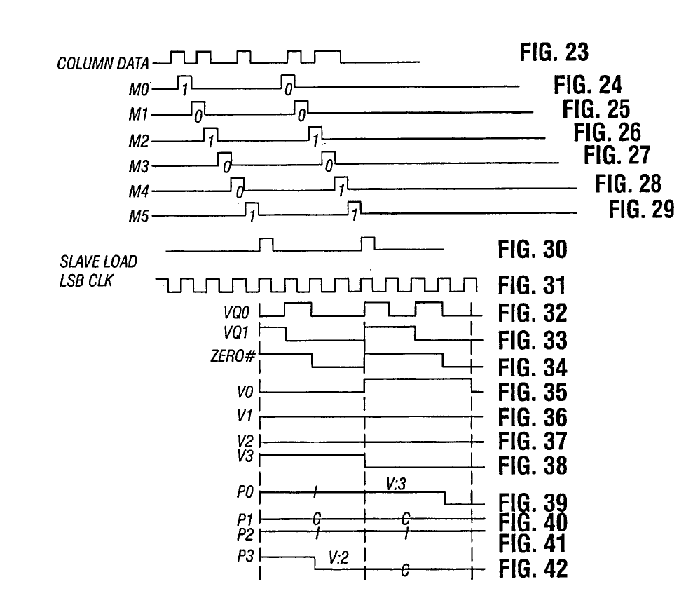

FIG. 22 depicts encoding circuitry 400 of the control circuitry 51 (FIG. 1) for controlling eight mirrors: circuitry 403 to control four mirrors of a particular group; and circuitry 405 to control four mirrors of another group. As an example, the mirrors associated with the circuitry 403 may be adjacent mirrors in a column of the array 50; and the mirrors associated with the circuitry 405 may be adjacent mirrors in a column of the array 50.

Referring to FIG. 22, each mirror has the following associated encoding circuitry. This circuitry includes a multiplexer 408 that has an output terminal that furnishes encoded data used to drive the associated pixel. The select terminal of the multiplexer 408 is coupled to a select line shared in common by the mirrors of each row. Thus, the multiplexers 408 that are associated with mirrors of row zero (for reference) are connected to a select line that receives a V0 signal and provide a signal called P0 at their output terminals; the multiplexers 408 that are associated with mirrors of the row one are connected to a select line that receives a V1 signal and provide a signal called P1 at their output terminals; the multiplexers 408 that are associated with mirrors of the row two are connected to a select line that receives a V2 signal and provide a signal called P2 at their output terminals; and the multiplexers 408 that are associated with mirrors of the row three are connected to a select line that receives a V3 signal and provide a signal called P3 at their output terminals.

One input terminal of the multiplexer 408 is connected to an output terminal of a countdown counter 402. The circuitry 403 has a countdown counter 402a that is shared by mirrors in its group; and the circuitry 405 has a countdown counter 402b that is shared by the mirrors in its group. Another input terminal of the multiplexer 408 is connected to the output terminal of a master-slave flip-flop 406. The flip-flop 406 includes a master latch with an input from a column data line 407 and is clocked by a sequencing signal M₀, M₁, M₂, M₃, etc. The slave latch of the flip-flop 406 has an input from the master latch and is clocked by a SLAVE LOAD signal, a signal that is asserted (driven high, for example) to cause the flip-flop 406 to latch the data present on an input terminal of the flip-flop 406. The M signals are “walking by one” sequential signals to load the column data. They may be generated, for example, by a ring counter. All of the M signals load the masters of the flip-flops 406 before the slaves of the flip-flops 406 are loaded via the SLAVE LOAD signal. It is noted that the additional potential signals M₆ through Mₙ (where “n” is six times the number of groups necessary to display all lines) and the associated circuitry are not depicted in FIG. 22.

The counter 402 also has a master, in some embodiments of the invention, that loads the column data value (from the column data line 107) when the M signal pulses (same as for the master-slave-flip-flop 406). Then the slave latch of the counter 402 loads and begins counting down on the SLAVE LOAD signal. This may use separate masters for the counter section.

The loading of the masters from the column data line 107 does not need to be synchronous with the LSB clock. Instead, all of the line and counter inputs must be latched from the column data line (with the M signals) before the SLAVE LOAD signal is pulsed to start the next field display cycle.

The V0, V1 and V2 signals (FIGS. 35-37) are de-asserted (driven low, for example) by the conclusion of the SLAVE LOAD pulse to cause the associated multiplexers 408 to select the output terminals of the associated flip-flops 406 and thus, cause the P0, P1 and P2 output signals (FIGS. 39-42) to be driven to the levels indicated by the values stored in the latches. Thus, for this example, the P0 signal is driven to a logic one level for the duration of the time slot T₀, the P1 signal is driven to a logic level of zero for the duration of the time slot T₀, and the P2 signal is driven to a logic level of one for the duration of the time slot T₀.

The V3 signal is asserted (driven high, for example) by the conclusion of the first depicted SLAVE LOAD pulse to select the P3 signal to indicate a single transition logic one pulse during the time slot T₀. Because the counter 402 of the group is loaded with a “2,” as depicted by the initial counter binary output signals called VQ0 (FIG. 32) and VQ1 (FIG. 33), the counter 402 counts down on each cycle of the LSB clock signal until the counter 402 asserts a ZERO# signal (FIG. 34) indicating that the end of the single pulse. Thus, the P3 signal is driven to a logic one during the time slot T₀ until the P3 and ZERO# signals are concurrently driven to logic zero states.

A similar procedure is followed to produce the P0-P3 signals in the time slot T₁. However, in this time slot, the P0 signal becomes the signal that indicates the single transition pulse; and the other P1-P3 signals are driven to various logic states for the duration of the time slot T₁. As depicted in FIGS. 35-38, for the time slot T₁, the VO signal is asserted (to designate the variable time slot); and the V1-V3 signals are de-asserted.

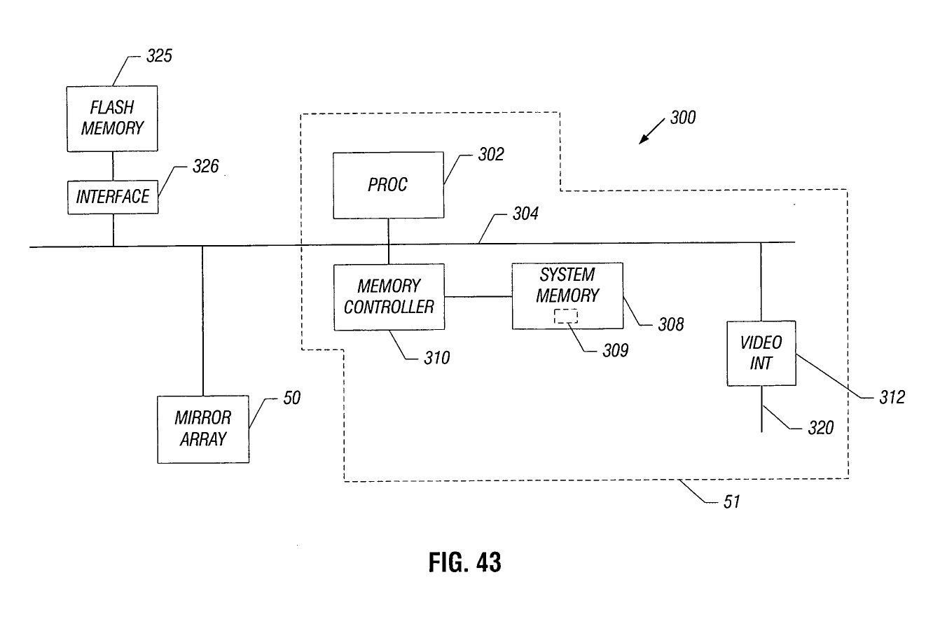

Referring to FIG. 43, in some embodiments of the invention, the control circuitry 51 may be part of a projection assembly 300 (see also FIG. 1) that may also include the mirror array 50, a flash memory 325 and a flash memory interface 326.

Regarding the control circuitry 51, this circuitry may include a processor 302 (a microprocessor, for example) that is coupled to a system bus 304. A memory controller 310 may also be coupled to the system bus 304 and control the storage and retrieval of data with a system memory 308. The controller 51 may include a video interface 312 that includes one or more input lines 320 for receiving a video signal. The video signal indicates a video to be displayed on the projection screen 150. The processor 302 may store data indicative of this video signal in the system memory 308 and perform video processing techniques on the data. The processor 302 may also retrieve data from the system memory 308 and store the data in the memory buffers of the mirror array 50 for purposes of controlling the images that are formed by the mirror array 50.

In some embodiments of the invention, the projection assembly 300 includes a flash memory 325 (coupled to the system bus 304 via the interface 326) for purposes of storing program instructions to cause the processor 302 to control the mirror array 50 as described herein. Thus, in some embodiments of the invention, the instructions that are stored in the memory 325 cause the processor 302 to, for each pixel, cell or mirror control the pixel cell/mirror with the techniques 170 and 180 that are generally depicted in FIGS. 3 and 4 and described above.

FIG. 43 depicts one out of many possible embodiments of the projection assembly. For example, in some embodiments of the invention, a frame buffer may be located between the processor 302 and the system bus 304. With this arrangement, the data from the processor need not be synchronous with the data on the system bus 304. As another example, in some embodiments of the invention, the mirror array 50 may be biased and signals provided to the mirror array 50 may be conditioned by circuitry not depicted in FIG. 43.

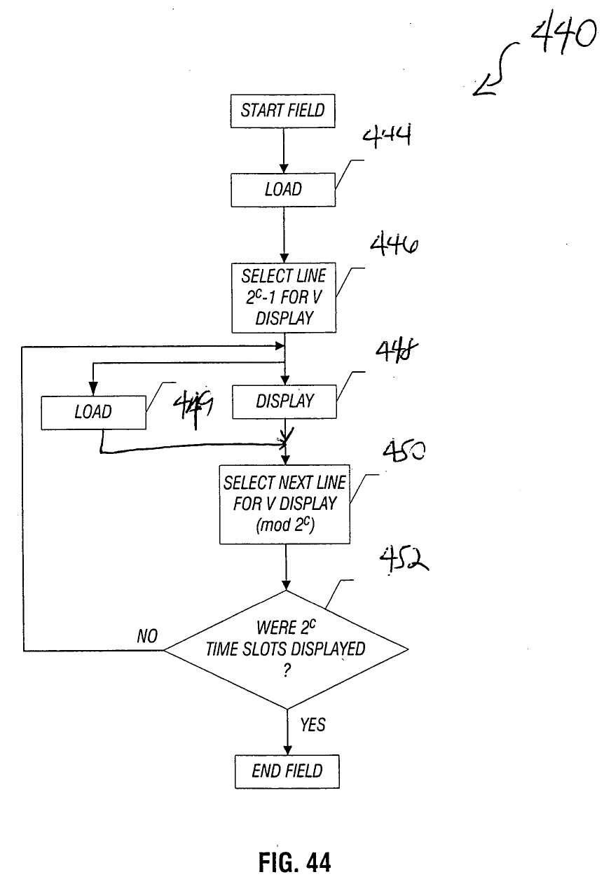

Referring to FIG. 44, in some embodiments of the invention, the mirror array 50 may function pursuant to a technique 440. More specifically, pursuant to the technique 440, the mirror array displays a particular field, a complete display of all pixels. There may be several fields per frame to display different colors and to reduce motion artifacts, depending on the particular embodiment of the invention.

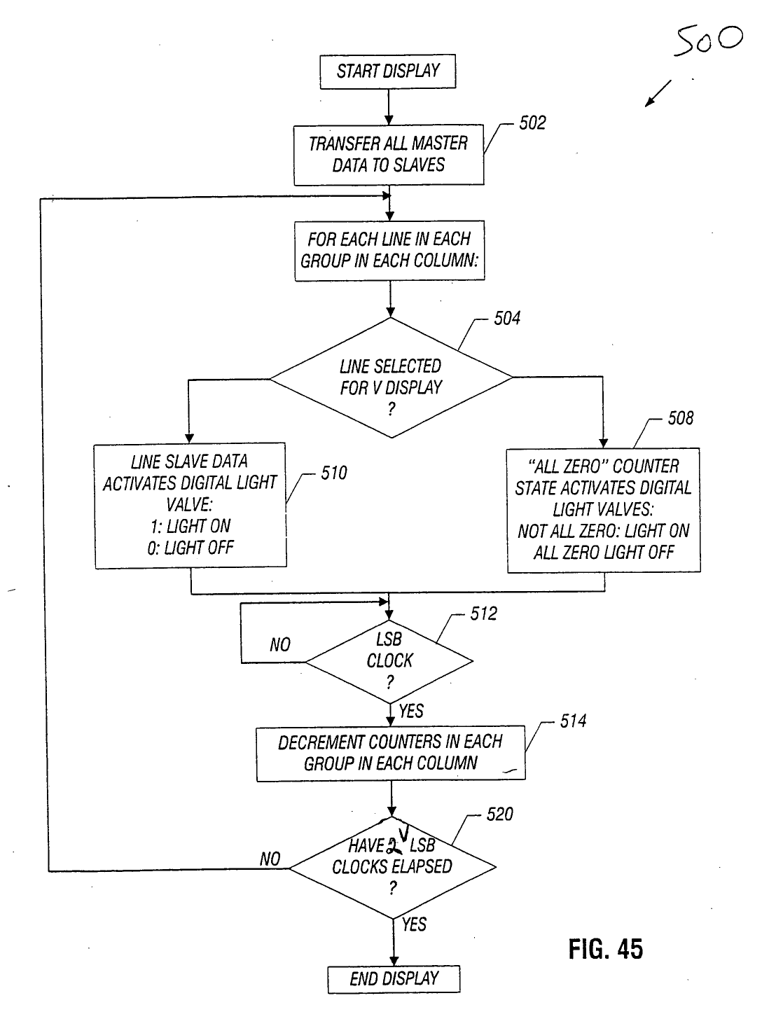

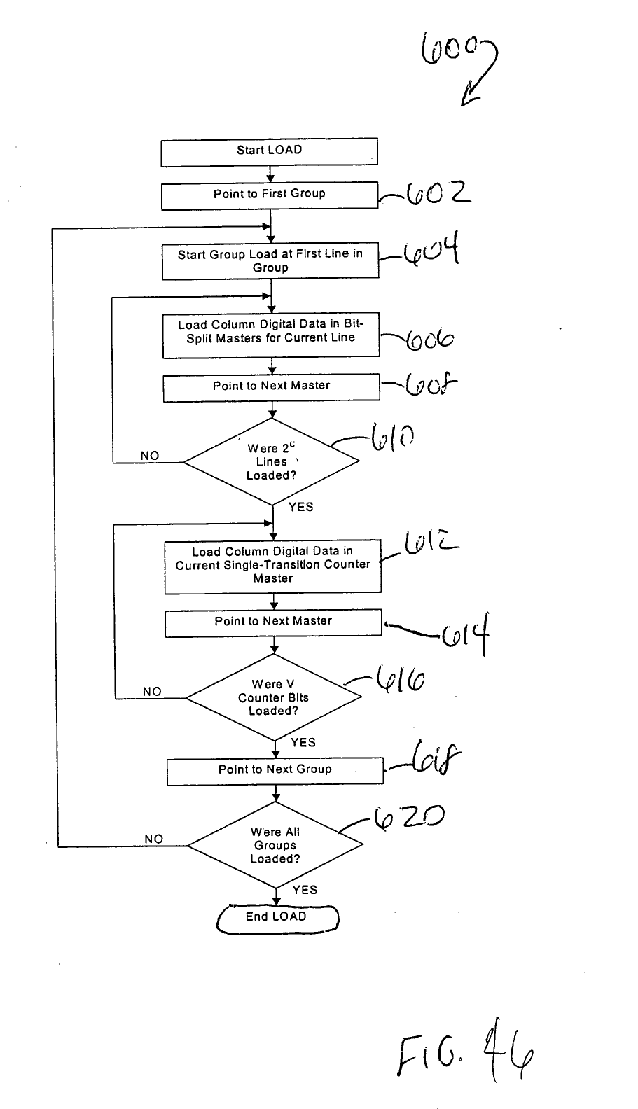

According to the technique 440, the first field is loaded (block 444) and then, the starting V line, line 2^{C}-1 for the V display, is selected as depicted in block 446. Next, the masters are loaded (block 449) at the same time the slaves control the light display (block 448). Specific exemplary implementations of blocks 448 and 449 are described in connection with FIGS. 45 (technique 500) and 46 (technique 600), respectively, below. The load time is shorter than the display time. Next, according to the technique 440, the next line for the V display is selected (block 450) for one line per group per time slot. If a determination (diamond 452) is made that all two 2^{C} time slots have been displayed, then this constitutes the end of the technique 440. Otherwise, control returns to blocks 448 and 449. It is noted that the starting V line is arbitrary and thus, may be another line, in some embodiments of the invention.

Referring to FIG. 45, in some embodiments of the invention, a technique 500 may be used to for purposes of displaying an image. Pursuant to the technique 500, all master data is transferred to the slaves, as depicted in block 502. Next, for each line in each group that each column the following steps are performed. First, a determination (diamond 504) is made whether a line has been selected for the V display. If so, then an “all zero” counter state activates the digital light valves. If the digital light valves selected for V display are on, then this indicates a non-zero state. Otherwise, if the counter has reached the all-zero state, then the light valves are turned off. If the light has not been selected for the V display, then control proceeds to block 510 in which the line slave data activates the digital light valve.

Next, according to the technique 500, a determination is made (diamond 512) whether the LSB clock has occurred. Once the LSB clock has occurred, then each counter is decremented in each group in each column, as depicted in block 514. If all 2^{V} LSB clocks have elapsed, then the technique 500 ends. Otherwise, control transitions back to diamond 504.

In some embodiments of the invention, a technique 600 that is depicted in FIG. 46 may be used to load the masters of the flip-flops 406. The technique 600 includes pointing (block 602) to the first group and starting the group load at the first line in the selected group, as depicted in block 604. Next, pursuant to the technique 600, the column digital data is loaded into bit-split masters for the current line, as depicted in block 606. Subsequently, the next master is selected, as depicted in block 608.

If a determination (diamond 610) is made that 2^{C} lines were loaded, then control transitions to block 612. Otherwise, control transitions back to block 606. Pursuant to block 612, the column digital data is loaded in the current single-transition counter master and then, the next master is selected, as depicted in block 614. If a determination is made that V counter bits have been loaded, then control transitions to block 618. Otherwise, control transitions back to block 612. Pursuant to block 618, the next group is selected and control proceeds to diamond 620 in which a determination a made whether all groups have been loaded. If so, then the end of the load is completed. Otherwise, control transitions back to block 604.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
applying a first encoding scheme to a first group of bits of a digital value;
applying a second encoding scheme different from the first encoding scheme to a second group of bits of the digital value; and
combining sequences generated by the first and second encoding schemes to drive a display device.

2. The method of claim 1, wherein the first group of bits are different from the second group of bits.

3. The method of claim 1, wherein the first group of bits comprises the most significant bits of the digital value and the second group of bits comprises the least significant bits of the digital value.

4. The method of claim 1, wherein the first encoding scheme comprises a bit splitting pulse encoding scheme.

5. The method of claim 4, wherein the second encoding scheme comprises a single transition pulse encoding scheme.

6. The method of claim 1, wherein the second encoding scheme comprises a single transition pulse encoding scheme.

7. The method of claim 1, wherein the display device comprises a mirror device.

8. The method of claim 1, wherein the display device is one out of a plurality of display devices, the method further comprising:
applying the first and second encoding scheme to encode other digital values; and
combining sequences derived from applying the first and second encoding schemes to drive other display devices of said plurality of display devices.

9. The method of claim 8, further comprising:
selectively phasing the beginning and ending of the application of the first and second encoding schemes.

10. An encoder comprising:
a first circuit to apply a first encoding scheme to a first group of bits of a digital value;
a second circuit to apply a second encoding scheme different from the first encoding scheme to a second group of bits of the digital value; and
a third circuit to combine sequences from the first and second encoding schemes to produce a signal to derive a display device.

11. The encoder of claim 10, wherein the first group of bits are different from the second group of bits.

12. The encoder of claim 10, wherein the first group of bits comprises the most significant bits of the digital value and the second group of bits comprises the least significant bits of the digital value.

13. The encoder of claim 10, wherein the first encoding scheme comprises a bit splitting encoding scheme.

14. The encoder of claim 13, wherein the second encoding scheme comprises a single transition pulse encoding scheme.

15. The encoder of claim 10, wherein the second encoding scheme comprises a single transition pulse encoding scheme.

16. The encoder of claim 10, wherein the display device comprises a mirror device.

17. The encoder of claim 10, wherein the display device is one out of a plurality of display devices, the method further comprising:
applying the first and second encoding scheme to encode other digital values; and
combining sequences derived from applying the first and second encoding schemes to drive other display devices of said plurality of display devices.

18. The encoder of claim 17, further comprising:
selectively phasing the beginning and ending of the application of the first and second pulse encoding schemes.

19. A system comprising:
a first encoder to apply a first encoding scheme to a first group of bits of a digital value;
a second encoder to apply a second encoding scheme different from the first pulse encoding scheme to a second group of bits of the digital value; and
a micromirror device coupled to the first encoder and the second encoder to control a tilt angle of a mirror in response to the applications of the first and second encoding schemes by the first and second encoders.

20. The system of claim 19, wherein the first group of bits are different from the second group of bits.

21. The system of claim 19, wherein the first group of bits comprises the most significant bits of the digital value and the second group of bits comprises the least significant bits of the digital value.

22. The system of claim 19, wherein the first encoding scheme comprises a bit splitting encoding scheme.

23. The system of claim 22, wherein the second encoding scheme comprises a single transition encoding scheme.
